(19) United States
(12) Patent Application Publication
(10) Pub. No.: US 2015/0081529 A1
(43) Pub. Date: Mar. 19, 2015

(54) METHOD OF MANAGING ONLINE REWARD CONTENT

(71) Applicant: NHN Entertainment Corporation, Seongnam-si (KR)

(72) Inventors: Hye-Ran LEE, Seongnam-si (KR); Jeong-Kwon Yang, Seongnam-si (KR); Gwang-Yeon Hwang, Seongnam-si (KR)

(21) Appl. No.: 14/474,768

(22) Filed: Sep. 2, 2014

(30) Foreign Application Priority Data
Sep. 17, 2013 (KR) 10-2013-0111506

(51) Int. Cl. G06Q 20/22; G06Q 30/02; G06Q 20/28

(52) U.S. Cl. CPC G06Q 20/227; G06Q 20/28; G06Q 30/0207
USPC 705/39

(57) ABSTRACT

A method of managing an online reward content according to on/off-line activities performed by a user, provides a method of managing and editing the issued online reward content and a rewards album, exchanging the obtained online reward content into digital money usable in a digital content store server, purchasing contents, or exchanging for another content with another user, and therefore, provides convenience to the user for managing online content.

### CROSS REFERENCE TO RELATED APPLICATIONS

This application claims priority from and the benefit of Korean Patent Application No. 10-2013-0111506, filed on Sep. 17, 2013, which is hereby incorporated by reference for all purposes as if fully set forth herein.

### BACKGROUND

1. Field

Exemplary embodiments of the present disclosure relate to a method of managing online reward content. More, particularly exemplary embodiments of the present disclosure relate to a management method and system for issuing online reward content as a result of a user performing an activity.

2. Discussion

Generally, a user may obtain reward contents such as points, coupons, stamps, etc. by performing on/off-line activities to earn a reward. Visiting an event area or a store within a specific period/time are examples of off-line activities, and, gaming, posting photos/blogs, writing notices/comments, etc., are examples of online activities, and a user may obtain reward contents by performing such activities. Also, some recent programs from which a user obtains stamps by achieving certain goals. The user can exchange these stamps for gift certificates or cyber money after achieving these goals. Since different programs assign different goals to a user, a user has to download to a mobile device a specific program to perform each goal. Therefore, when a user achieves a number of goals, the user has to separately download and manage the programs, which is inconvenient when the user wants to achieve a number of goals. Also, the reward contents are issued through an e-mail or specific web-site; therefore in order to download the reward contents, a user has to log-in to a mail account or a specific web-site.

In addition, the downloaded reward contents are managed independently in a mobile device or PC; therefore, it is inconvenient for the user to search for these rewards on a mobile device. Further, coupons or points that are given as the reward contents can only be used in a specific store or web-site.

### SUMMARY

In one embodiment of the present disclosure, a method of managing online reward content includes providing on/off-line activities, obtaining online reward content or a rewards album by performing the activities, moving the obtained online reward content to a rewards album, and editing the issued online reward content in the rewards album. In one embodiment, editing the rewards album may be one of adding, moving and deleting the online reward content. In one embodiment, the online reward content may be a digital badge or points.

A method of managing online reward content according to an embodiment of the present disclosure may further include exchanging the online reward content for digital money usable in a digital content store server.

A method of managing online reward content according to an embodiment of the present disclosure may further include purchasing online content from a digital content store server. In one embodiment, the purchased content may be an online content, a rewards album, or game content, and the rewards album may include a personalized rewards album which is editable by a user.

A method of managing online reward content according to an embodiment of the present disclosure may further include purchasing additional digital money through payment.

A method of managing online reward content according to an embodiment of the present disclosure may further include exchanging the online reward content for desired online content with a second user from the digital content store server. In one embodiment, the exchanged online reward content may be a digital badge.

As described above, a method of managing online reward content according to an embodiment of the present disclosure provides a convenient and easy way for a user to manage online reward content by proving on/off-line activities, providing a managing and editing method of online reward content obtained by performing the activities, exchanging the obtained online reward content for digital money usable in a digital online store, and purchasing contents or exchanging for desired content with another user.

### BRIEF DESCRIPTION OF THE DRAWING

The accompanying drawings, which are included to provide a further understanding of the disclosure and are incorporated in and constitute a part of this specification, illustrate embodiments of the disclosure, and together with the description serve to explain the principles of the disclosure.

FIG. 1 is a diagram explaining a method of issuing online reward content according to an embodiment of the present disclosure;

FIG. 2 is a flow chart showing a method of issuing and editing online reward content according to an embodiment of the present disclosure;

FIG. 3 is a flow chart showing a method of exchanging online reward content according to an embodiment of the present disclosure; and

FIG. 4A and FIG. 4B are images showing display state using a method of managing online reward content according to an embodiment of FIG. 2.

### DETAILED DESCRIPTION OF THE ILLUSTRATIVE EMBODIMENTS

The present disclosure is described more fully hereinafter with reference to the accompanying drawings, in which embodiments of the present disclosure are shown. The present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. In the drawings, the sizes and relative sizes of layers and regions may be exaggerated for clarity.

It will be understood that, although the terms first, second, third etc. may be used herein to describe various elements, components, regions, layers and/or sections, these elements, components, and/or sections should not be limited by these terms. These terms are only used to distinguish one element, component, region, layer or section from another region, layer or section. Thus, a first element, component, or section discussed below could be termed a second element, component, or section without departing from the teachings of the present disclosure.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, with reference to the drawings, preferred embodiments of the present disclosure will be described in detail.

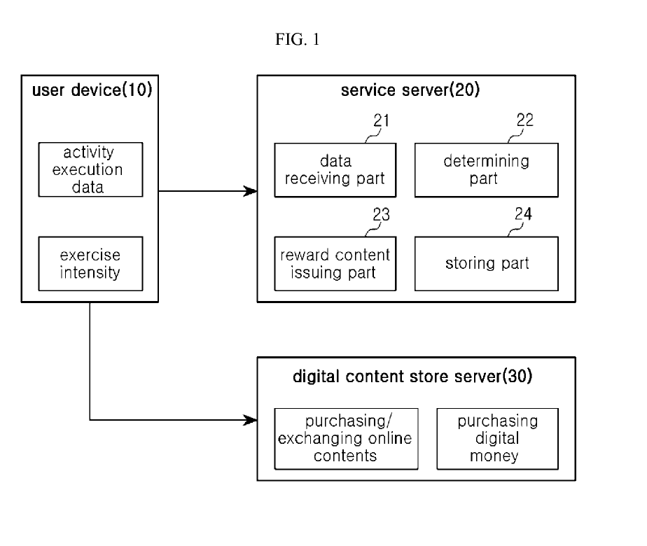

FIG. 1 is a diagram explaining a method of issuing online reward content according to an embodiment of the present disclosure.

Referring to FIG. 1, a system providing online reward content for an activity performed by a user according to an embodiment of the present disclosure may include at least one user device 10 and a service server 20. The user device 10 monitors a user's execution of a selected activity and generates activity execution data according to the monitored user's execution and transmits the activity execution data to the service server 20. Herein, the user device may be a smartphone or a tablet or other mobile computing device. The service server 20 compares the activity execution data to reward condition information to determine whether and what to issue from online content to the user, and provides the online content to the user when the activity execution data meet the reward condition information. The service server 20 may include a data receiving part 21 which receives the activity execution data from the user device 10, a determining part 22 which calculates using the activity execution data and determines reward condition information of the online content, which is stored in a database, corresponding to the activity execution data, a reward content issuing part 23 which issues the online content according to the result of the determining part 22 to the user device 10, and a storing part 24 which stores a record of the activity execution data transmitted from the user device 10 and the issued online content after issuing the online content. The online content provided by service server 20 as a reward includes an online reward content, an item-book (which may also be referred to as an “item-book” or a “rewards album”), and points. The online reward content includes a digital badge and points that may be redeemable for digital money.

The determining part 22 selects the online content corresponding to standardized activity execution data according to a type of an activity, or, selects the online content according to calculated data which is calculated based on the activity execution data which is measured by the user device 10.

Herein, the calculated data based on the activity execution data may be an exercise intensity such as a moving path, moving distance, moving velocity, or calories consumed by a person performing the exercise.

The system according to an embodiment of the present disclosure may further include a digital content store server 30 which receives online reward content by the user device 10. When the user wants to sell the online reward content, the digital content store server 30 exchanges the online reward content to digital money and transmits the digital money to the user device 10. When the user wants to exchange the online reward content, the digital content store server 30 searches desired online content or another user possessing the desired online content and transmits the result to the user device 10. The online reward content transmitted by the user device 10 may be a duplicated content or an unnecessary content.

The user may purchase other online content from a digital content store server 30 through the digital money obtained by exchanging the online reward content. A rewards album, online content, or game content may be purchased from the digital content store server 30, and the rewards album includes a personalized rewards album which is editable by the user.

Also, the user may obtain additional digital money through payment in the case of insufficient digital money during purchase of online content.

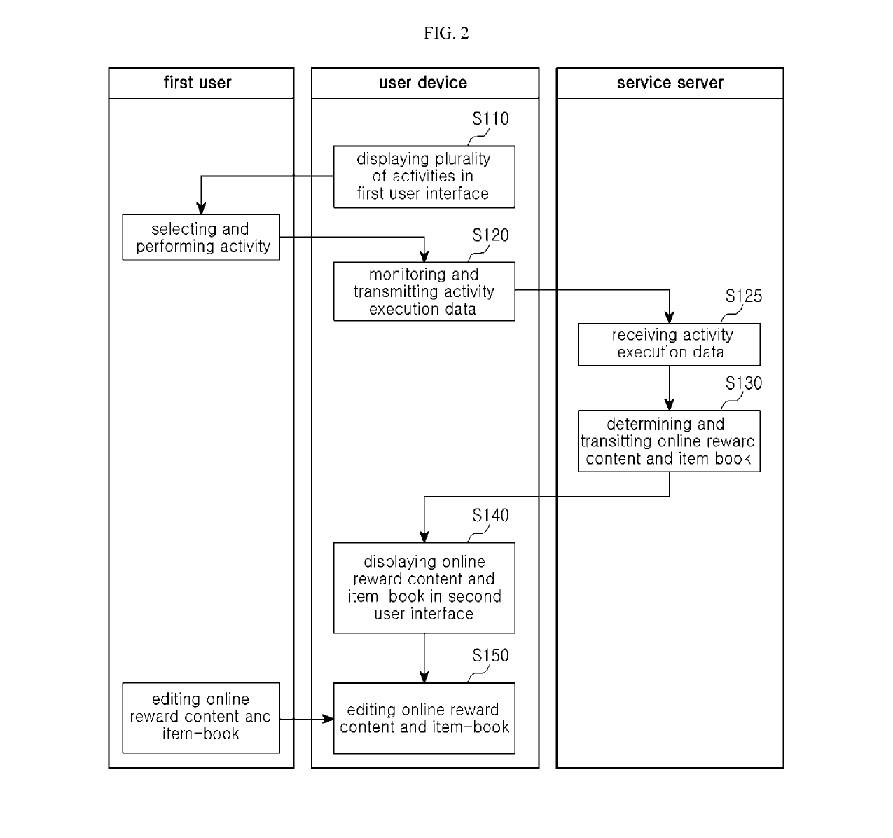

FIG. 2 is a flow chart showing a method of issuing and editing online reward content according to an embodiment of the present disclosure.

A detailed explanation of a method of managing an online reward content is described with reference to FIG. 2.

First, in a step S110, a user device 10 provides a first user interface that displays a plurality of selectable activities and at least one activity of the plurality of activities is selected by a user. The user device 10 accesses a service server 20 which issues online reward content, and displays activities in a menu in which a user selects an activity. Examples of such activities may include a habitual physical activity (stretching, stair climbing, etc.), an exercise without using equipment (running, walking, hiking, etc.), and an exercise using equipment (golf, skiing, riding, etc.).

Then, in step S120, the user device 10 monitors a user's execution of the activity which is selected by the user to generate activity execution data based on the user's execution and transmits the activity execution data to the service server 20.

Next, in step S125, the service server 20 receives the activity execution data from the user device 10.

Then, in step S130, the service server 20 determines whether to issue a reward based on the activity execution data, and transmit the result to the user device 10.

For example, the service server 20 calculates a moving path, a moving distance, a moving velocity, or calories consumed by the user by using the activity execution data, and determines whether to issue a reward and which online reward content should be issued based on the calculated data.

During the step of determining whether to issue the reward, the service server 20 may limit a maximum number of issuance of the online reward content based on the fact that the reward may be issued with a predetermined probability every predetermined time.

The predetermined time and the probability may be varied based on the type of activity selected by the user.

In one embodiment, it is typical that a habitual activity such as doing housework burns up fewer calories than an activity such as running or riding. Therefore, the former activity may be set less frequently than the latter activity. For example, a habitual activity may be set every 60 min. with 10% probability, while an activity such as a running may be set every 30 min. with 60% probability, therefore, an activity with higher exercise intensity has a greater chance of earning a reward.

To give a differentiated reward according to an exercise intensity, the service server 20 may include a database to store information of a standardized exercise intensity according to a type of an activity, and the service server 20 may calculate a real exercise intensity of the user and store the result based on measured data by the user device 10, geographical information and the standardized exercise intensity.

In one embodiment, the service server 20 may store a standardized exercise intensity for each activity, and a reward determining time and a probability associated with it.

Herein, the service server 20 may calculate a moving velocity and a moving path of the user device 10 by receiving position information from a GPS of the user device 10, and calculate a gradient of the moving path and a distance, etc. of the activity of the user by using external geographical information (not shown) or geographical information stored in the service server 20. The service server 20 may calculate an exercise intensity of the user by using geographical information executed during execution the activity of the user and a moving velocity of the user. For example, a relative exercise intensity of the activity may be evaluated by calculating calorie consumption using pre-stored body information of the user, an exercise intensity calculated by the service server 20, and a duration time of the activity.

The above description explains the situation in which the service server 20 calculates an exercise intensity using position information transmitted by the user device 10 and geographical information; alternatively, the user device 10 may calculate an exercise intensity by using position information of the user device 10 and geographical information transmitted by the service server 20, and transmit the calculated result to the service server 20.

Also, the service server 20 may transmit a message to the user device 10 to inform the user device regarding an issue of the online reward content.

Also, when the online reward content is issued, the user device 10 or the service server 20 may initialize the activity execution data to start to measure the predetermined time from the beginning, and after the predetermined time interval, determines again whether to issue online reward content according to the predetermined probability. Alternatively, when the online reward content is not issued, the user device 10 or the service server 20 continues to measure the an activity execution data by accumulating the activity execution data, and the service server 20 may increase the online reward content issuing probability according to the accumulated activity execution data.

In one embodiment, online reward content is issued according to a first 30 min. with 30% of probability when a user selects walking as an activity, however, when the online reward content is not issued after the above condition, the activity execution data is not initialized but accumulated, and after another 30 min (60 min in total), the service server 20 determines to issue the online reward content according to 60% of the probability.

Next, in step 140, the user device 10 provides a second user interface which displays the online reward content determined by the service server 20 and a rewards album. As used herein, the term “rewards album” is any container, directory, folder, etc. in a mobile device that holds and optionally organizes rewards content for the conveniences of the user. Herein, the second user interface may include another online reward content which is pre-issued before the online reward content.

Next, in step S150, the user device 10 provides an editing function of the online reward content displayed in the second user interface. Herein, the editing function may include moving or adding the online reward content to a rewards album by the user, moving or adding the another online reward content which is pre-issued before the online reward content to the rewards album, and also, deleting the online reward content.

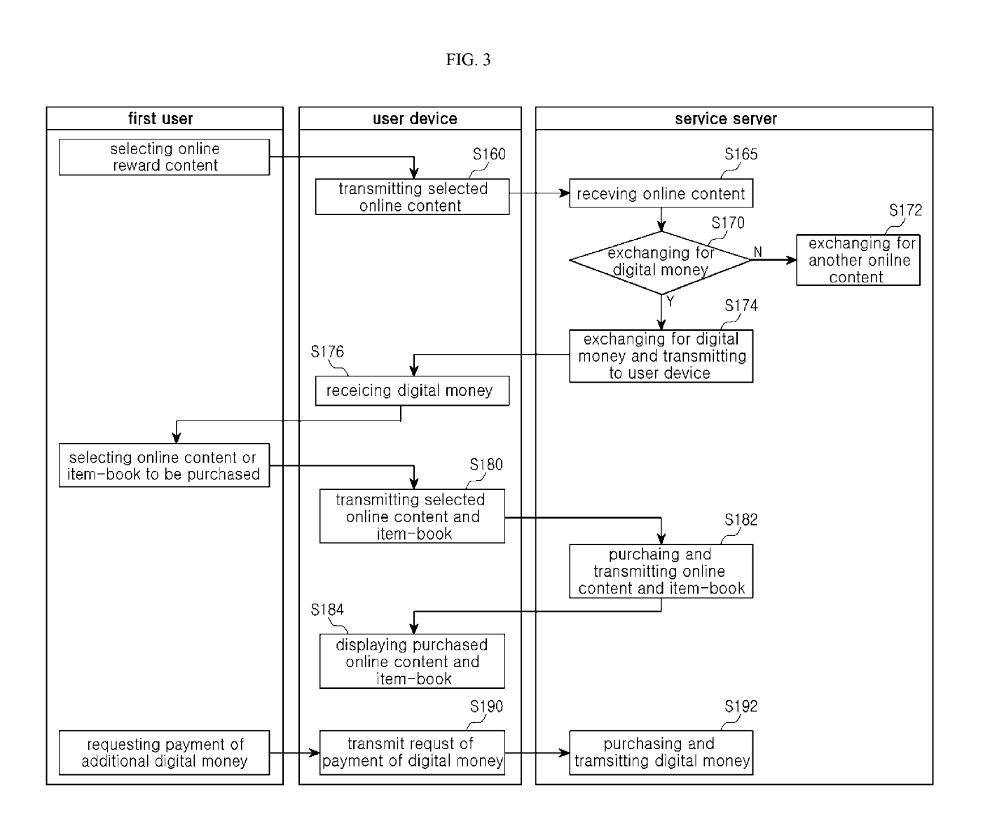

FIG. 3 is a flow chart showing a method of exchanging an online reward content according to an embodiment of the present disclosure.

A detailed explanation of a method of exchanging an online reward content is described with reference to FIG. 3.

Referring to FIG. 3, in step S160, the user device 10 may further transmit an online reward content which is selected by the user to send to the digital content store server 30. The transmitted online reward content may be a duplicated reward content or an unnecessary reward content.

Next, in step S165, the digital content store server 30 receives the online reward content selected by the user, in step S170, and determines whether to exchange the online reward content for digital money or for another online content. In step S174, which is a case of exchanging for digital money, the online reward content is exchanged for digital money and the digital money is transmitted to the user device 10. Alternatively in step S172 the online reward is exchanged for other online content. In step 172 a search is performed for the other online content or for a user possessing the other online content. The result of the search is transmitted to the user device 10.

In step 176, the user device 10 receives the digital money obtained by exchanging the online reward content. The user may then further select online content or a rewards album from the digital content store server 30 to be purchased with the digital money. In step S180, the selected online content of the rewards album is transmitted to the digital content store server 30. Herein the rewards album includes a personalized rewards album which is editable by the user.

Next, in step 182, the digital content store server 30 may further purchase the online content or the rewards album transmitted by the user device 10, and transmit it to the user device 10.

Then, in step 184, the user device 10 may further display the online content and the rewards album transmitted by the digital content store server 30.

Also, in step 190, the user device 10 may further purchase additional digital money through payment in the event of insufficient digital money during the purchase process.

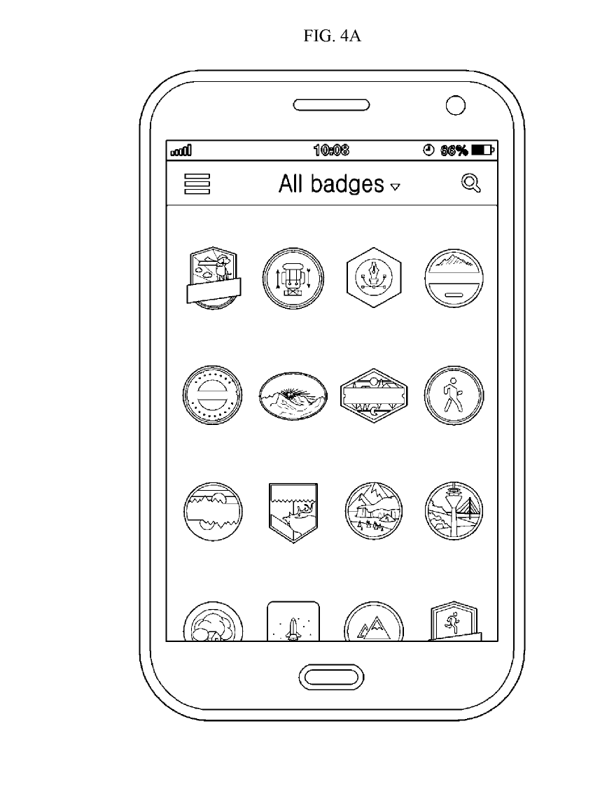

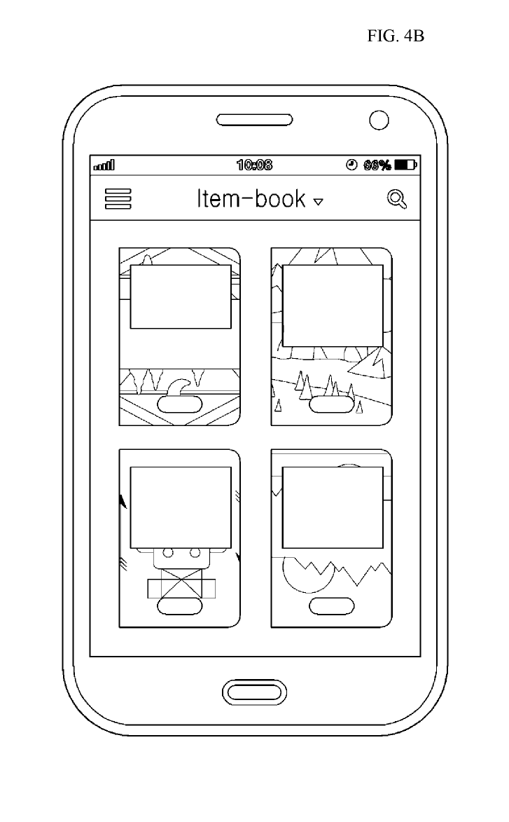

FIG. 4A and FIG. 4B are images showing a display state using a method of managing an online reward content according to an embodiment of FIG. 2.

Referring to FIG. 4A, a user may possess various online reward contents by performing a variety of activities as shown in FIG. 4A. The user may move the various online reward contents, for example, by moving them to a rewards album through an editing function as shown in FIG. 4B. As seen in FIG. 4B, the rewards album may be a personalized rewards album which is edited/organized by a theme or a category.

Several steps of the present disclosure are implemented using a coded program, which can be read by a computer, on a computer readable recording medium.

Examples of the computer-readable recording medium include ROM, RAM, CD-ROM, magnetic tapes, floppy disks, optical data storage devices, etc. (e.g., transmission through the Internet), and the like. The computer readable recording medium in a computer system can be connected to a network in a distributed manner by the computer readable code that is stored and executed.

What is claimed is:

1. A method of managing an online reward content according to an activity performed by a user, wherein the method is performed by a user device and a service server, comprising:
(a) selecting at least one activity on a user device;
(b) monitoring, through said user device, the user's execution of the selected activity thereby generating activity execution data, and transmitting the activity execution data to a service server;
(c) comparing said user's activity execution data with requirements for awarding a reward for activity in said service server; and
(d) providing a second user interface in said user device which displays any reward found awardable by said service server comparison.

2. The method of claim 1, further comprising (e) editing the online reward content displayed on the second user interface, wherein (e) is performed by the user device.

3. The method of claim 2, wherein the online reward content includes at least one of a digital badge and points exchangeable for digital money.

4. The method of claim 2, wherein the second user interface further displays a rewards album, and (e) comprises adding or moving the online reward content displayed in the second interface to the rewards album.

5. The method of claim 4, wherein (e) further comprises step of deleting the online reward content displayed from the second user interface, or deleting the online reward content from the rewards album.

6. The method of claim 1, further comprising (f) transmitting the online reward content to a digital content store server, wherein (f) is performed by the user device.

7. The method of claim 6, wherein the online reward content transmitted to the digital content store server is a digital badge.

8. The method of claim 6, wherein the online reward content transmitted to the digital content store server is a duplicated content or an unnecessary content.

9. The method of claim 6, further comprising:
(g) determining whether the received online reward content is exchangeable for digital money, wherein (g) is performed by the digital content store server;
(h) exchanging the received online reward content for digital money and transmitting the digital money to the user device if the received reward content is determined exchangeable, wherein (h) is performed by the digital content store server; or
(i) searching another online content or a user possessing other online contents and transmitting the result of the search to the user device if the received reward content is not determined exchangeable, wherein (i) is performed by the digital content store server.

10. The method of claim 9, further comprising (j) purchasing another online content in the digital content store server by using the digital money, wherein (j) is performed by the user device.

11. The system of claim 10, wherein the other online content purchased from the digital content store server includes an online content and a personalized rewards album editable by the user.

12. The system of claim 10, wherein (j) further comprises purchasing additional digital money through a payment in the event of insufficient digital money.

13. The method of claim 1, wherein the activity selected by the user through the first user interface includes a habitual physical activity, an exercise without using equipment, and an exercise using equipment.

14. The method of claim 1, wherein (c) comprises calculating at least one of a moving path, a moving distance, and a calorie consumption of the user using the activity execution data, and determining whether to issue a reward and which online reward content to issue based on the result of the calculation.

15. The method of claim 14, wherein a number of reward issuances and a reward probability of the online reward content are determined based on a type of the activity selected by the user or the result of the calculation.

16. An online reward content management system providing online content as a reward according to an activity performed by a user, comprising:
a) a user device which displays a first user interface displaying a plurality of selectable activities;
b) a service server to which is transmitted data reflecting performance of a selected activity from said user device which service server evaluates said transmitted data to determine if a reward is due by reason of said activity,
c) wherein said user device comprises a second user interface displaying a reward determined to be due by the service server, and said user device further comprises an editing part providing an editing function of the online reward content displayed in the second user interface.

17. The system of claim 16, wherein the online reward content includes at least one of a digital badge and points exchangeable for digital money.

18. The system of claim 16, wherein the second user interface further displays a rewards album, and the editing part moves or adds the online reward content to the rewards album, or deletes the online reward content stored in the second user interface and the rewards album.

19. The system of claim 16, wherein the transmission part transmits the online reward content to a digital content store server.

20. The system of claim 19, wherein the digital content store server receives the online reward content transmitted by the user device, determines whether the received online reward content is exchangeable for a digital money or for another online reward content, exchanges for the digital money or searching another online content or a user possessing the another online reward content according to the determination, and transmitting the result to the user device.

21. The system of claim 20, wherein the user device further purchases an online reward content and the rewards album using the digital money from the digital content store server.

22. The system of claim 21, wherein the purchased online reward content includes a digital badge and a personalized rewards album editable by the user.
